(19) United States
(12) Patent Application Publication
(10) Pub. No.: US 2008/0160836 A1
(43) Pub. Date: Jul. 3, 2008

(54) CABLE CONNECTOR PLUG HAVING CONTACT WITH ANTI-ROTATION MEMBER

(75) Inventors: WU-KUANG CHEN, Tu-Cheng (TW); HSIAW-CHIANG CHEN, Tu-Cheng (TW); MIN-QIANG ZHANG, Shenzhen (CN); CHANG-HUA LIAO, Shenzhen (CN); GUO-ZHONG LIU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/672,872

(22) Filed: Feb. 8, 2007

(30) Foreign Application Priority Data
Dec. 29, 2006 (CN) 200610201468.2

(51) Int. Cl. H01R 24/04; H01R 13/631

(52) U.S. Cl. 439/668; 439/345

(57) ABSTRACT

An exemplary cable connector plug includes a first contact, a second contact and a first insulator portion. The first contact and the second contact are insulated from each other by the first insulator portion. The second contact includes an annular contact portion, the annular contact portion surrounding the first insulator. The annular contact portion includes an anti-rotation member defined at an inner side thereof, and the insulator portion is engaged with the anti-rotation member such that the annular contact portion cannot rotate relative to the first insulator portion. The anti-rotation member of the present cable connector plug prevent or avoid the occurrence of displacement as between adjacent contacts of the cable connector plug.

### CROSS-REFERENCE TO RELATED APPLICATIONS

This application is related to two co-pending U.S. patent applications, application serial no. [to be advised] (Docket No. US13427), entitled “CABLE CONNECTOR PLUG HAVING CONTACT WITH CURVED EXTENSION PORTION”, wherein the inventor is Wu-Kuang Chen et al, and application serial no. [to be advised] (Docket No. US13428), entitled “CABLE CONNECTOR PLUG HAVING CONTACT WITH HOOKING PORTION”, wherein the inventor is Wu-Kuang Chen et al. Such applications have the same assignee as the present application and have been concurrently filed herewith. The disclosures of the above identified applications are incorporated herein by reference.

### BACKGROUND OF THE INVENTION

1. Field of the Invention

The present invention relates to electrical connector plugs, and more particularly to a cable connector plug used in a connector for transmitting audio signals or other signals.

2. Discussion of the Related Art

FIG. 5 is a side cross-sectional view of a conventional cable connector plug 10. The cable connector plug 10 includes a first contact 11, a second contact 12, a third contact 13, a fourth contact 14, and a plurality of insulators 15 between the contacts 11, 12, 13, 14. The contacts 11, 12, 13, 14 are electrical conductors, and are insulated from each other by the insulators 15.

The first contact 11 includes a contact portion 110, an extension portion 111 extending rearwardly from the contact portion 110 along an axis of the cable connector plug 10, and a rear portion 112 extending rearwardly from the extension portion 111. The second and third contacts 12, 13 respectively include an annular contact portion 120, 130, a cylindrical extension portion 121, 131 extending rearwardly from the contact portion 120, 130, and a rear portion 122, 132 extending from the extension portion 121, 131. The fourth contact 14 includes a cylindrical contact portion 140, an annular extension portion 141 extending rearwardly from the contact portion 140, and a rear portion 142 extending from the extension portion 141. The extension portions 111, 121, 131, 141 of the first, second, third, and fourth contacts 11, 12, 13, 14 are coaxially arranged in that order from an inside to an outside of the cable connector plug 10. Accordingly, diameters of the extension portions 111, 121, 131, 141 increase in that sequence. The contact portions 110, 120, 130, 140 of the contacts 11, 12, 13, 14 are insulated from each other by a plurality of annular insulating ring portions (not labeled) of the insulators 15. The extension portions 111, 121, 131, 141 of the contacts 11, 12, 13, 14 are insulated from each other by a plurality of cylindrical portions (not labeled) of the insulators 15.

The rear portion 112 of the first contact 11 extends rearwardly beyond the insulators 15 for soldering with a first wire (not shown) of a cable (not shown). A rearmost part of the rear portion 122 of the second contact 12 is exposed for soldering with a second wire (not shown) of the cable. The other part of the rear portion 122 of the second contact 12 is embedded between the corresponding insulators 15. A rearmost part of the rear portion 132 of the third contact 13 is exposed for soldering with a third wire (not shown) of the cable. The other part of the rear portion 132 of the third contact 13 is embedded between the corresponding insulators 15. The rear portion 142 of the fourth contact 14 extends perpendicularly outward from the insulator 15 that is between the third and fourth contacts 13, 14, and is for soldering with a fourth wire (not shown) of the cable.

Generally, surfaces of the second contact 12 are smooth surfaces. When the cable connector plug 10 is inserted into a mating socket of a housing of a complementary connector and rotated relative to the housing, the second contact 12 may easily slide and/or rotate relative to the first contact 11. When this happens, a binding strength as between the first and second contacts 11, 12 is reduced. Thus the cable connector plug 10 is liable to loosen and malfunction or even break apart.

What is needed, therefore, is a new cable connector plug which can overcome the above-described shortcomings.

### SUMMARY

A cable connector plug according to a preferred embodiment includes a first contact, a second contact and a first insulator portion. The first contact and the second contact are insulated from each other by the first insulator portion. The second contact includes an annular contact portion, the annular contact portion surrounding the first insulator. The annular contact portion includes a first anti-rotation member defined at an inner side thereof, and the insulator portion is engaged with the first anti-rotation member such that the annular contact portion cannot rotate relative to the first insulator portion.

Other novel features and advantages will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present cable connector plug. Moreover, in the drawings, like reference numerals designate corresponding parts throughout the several views, and all the views are schematic.

FIG. 1 is an isometric view of a cable connector plug according to a first preferred embodiment of the present invention, the cable connector plug including a first contact, a second contact, a third contact, and a fourth contact.

FIG. 2 is a side, cross-sectional view of the cable connector plug of FIG. 1, taken along line 11-11 thereof.

FIG. 3 is a side, cross-sectional view of the second contact of the cable connector plug shown in FIG. 2.

FIG. 4 is a side, cross-sectional view of a cable connector plug according to a second preferred embodiment of the present invention.

FIG. 5 is a side, cross-sectional view of a conventional cable connector plug.

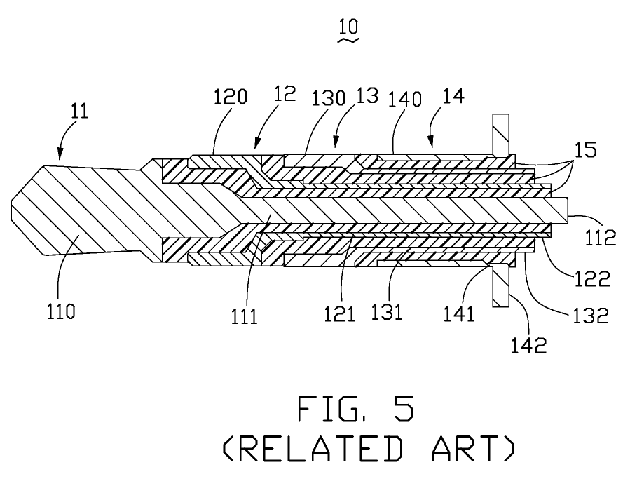

### DETAILED DESCRIPTION OF THE PREFERRED EMBODIMENTS

Reference will now be made to the drawings to describe preferred embodiments of the present cable connector plug, in detail.

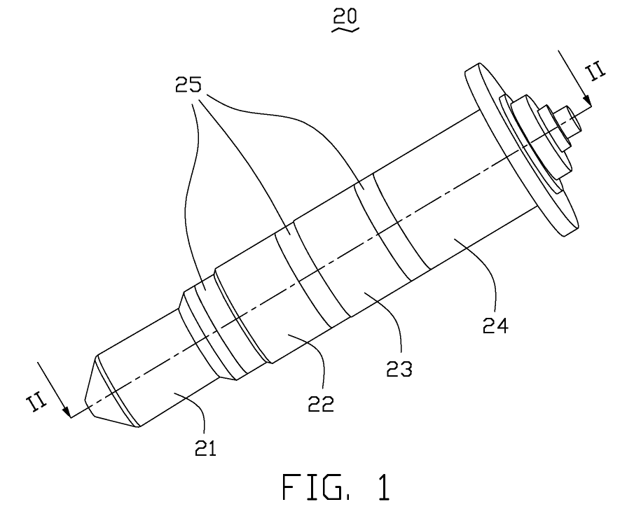

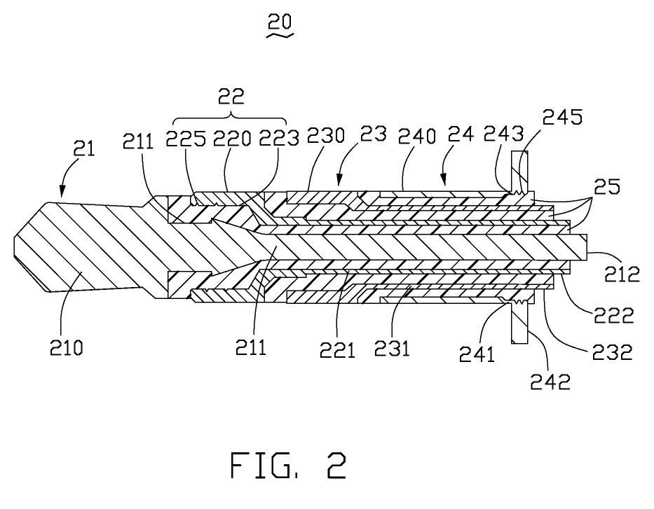

Referring to FIGS. 1 and 2, a cable connector plug 20 according to a first preferred embodiment of the present invention is shown. The cable connector plug 20 includes a first contact 21, a second contact 22, a third contact 23, a fourth contact 24, and a plurality of insulators 25. The contacts 21, 22, 23, 24 are made of metallic material, and are insulated from each other by the insulators 25. The first contact 21 includes a contact portion 210, an extension portion 211 extending rearwardly from the contact portion 210 along an axis of the cable connector plug 20, and a rear portion 212 extending rearwardly from the extension portion 211.

The second and third contacts 22, 23 respectively include an annular contact portion 220, 230, a cylindrical extension portion 221, 231 extending rearwardly from the contact portion 220, 230, and a rear portion 222, 232 extending rearwardly from the extension portion 221, 231. The fourth contact 24 includes a cylindrical contact portion 240, an annular extension portion 241 extending rearwardly from the contact portion 240, and a rear portion 242 extending from the extension portion 241. The extension portions 211, 221, 231, 241 of the first, second, third, and fourth contacts 21, 22, 23, 24 are coaxially arranged in that order from an inside to an outside of the cable connector plug 20. Accordingly, diameters of the extension portions 211, 221, 231, 241 increase in that sequence. The contact portions 210, 220, 230, 240 of the contacts 21, 22, 23, 24 are insulated from each other by a plurality of ring portions (not labeled) of the insulators 25. The extension portions 211, 221, 231, 241 of the contacts 21, 22, 23, 24 are insulated from each other by a plurality of cylindrical portions (not labeled) of the insulators 25.

The rear portion 212 of the first contact 21 extends rearwardly beyond the insulators 25 for soldering with a first wire (not shown) of a cable (not shown). A rearmost part of the rear portion 222 of the second contact 22 is exposed for soldering with a second wire (not shown) of the cable. The other part of the rear portion 222 of the second contact 22 is embedded between the corresponding insulators 25. A rearmost part of the rear portion 232 of the third contact 23 is exposed for soldering with a third wire (not shown) of the cable. The other portion of the rear portion 232 of the third contact 23 is embedded between the corresponding insulators 25. The rear portion 242 of the fourth contact 24 extends perpendicularly outward from the insulator 25 that is between the third and fourth contacts 23, 24, and is for soldering with a fourth wire (not shown) of the cable.

The cable connector plug 20 can be manufactured by way of insert molding. In a typical process, firstly, the contacts 21, 22, 23, 24 are manufactured by a machining method. Secondly, the cable connector plug 20 is integrally assembled by an insert molding method. In particular, the contacts 21, 22, 23, 24 are coaxially aligned in a mold. Molten insulating material is injected into the mold and fills spaces between the contacts 21, 22, 23, 24. The cooled insulating material forms the insulators 25 of the cable connector plug 20.

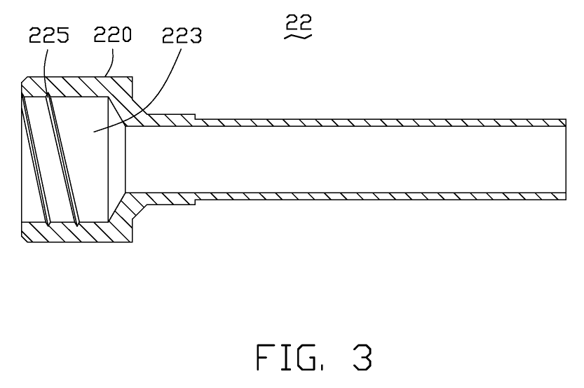

Referring to FIGS. 2 and 3, the contact portion 220 of the second contact 22 has an inner surface 223. The inner surface 223 is in immediate contact with the insulator 25 that substantially surrounds the first contact 21. A first anti-rotation member 225 is defined at the inner surface 223. The first anti-rotation member 225 is configured to lockingly engage with the insulator 25. For example, the first anti-rotation member 225 can include a plurality of depressions or one or more grooves, which are defined at the inner surface 223. The depressions can be contiguous elongated depressions or discrete depressions. In this embodiment, the first anti-rotation member 225 includes a screw thread groove. Correspondingly, the insulator 25 has a screw thread that matches the screw thread groove. Thereby, a mechanical bonding strength between the insulator 25 and the second contact 22 is increased. Accordingly, when the cable connector plug 20 is inserted into a mating socket of a housing of a complementary connector and rotated relative to the housing, displacement as between the second contact 22 and the first contact 21 is avoided.

Referring to FIG. 2, similarly, the extension portion 242 of the fourth contact 24 has an inner surface 243. The inner surface 243 is in immediate contact with the insulator 25 that substantially surrounds the third contact 23. A second anti-rotation member 245 is defined at the inner surface 243. The second anti-rotation member 245 is configured to lockingly engage with the insulator 25. For example, the second anti-rotation member 245 can include a plurality of depressions or one or more grooves, which are defined at the inner surface 243. The depressions can be contiguous elongated depressions or discrete depressions. In this embodiment, the second anti-rotation member 245 includes a screw thread groove. Correspondingly, the insulator 25 has a screw thread that matches the screw thread groove. Thereby, a mechanical bonding strength between the insulator 25 and the fourth contact 24 is increased. Accordingly, when the cable connector plug 20 is inserted into the mating socket of the housing of the complementary connector and rotated relative to the housing, displacement as between the fourth contact 24 and the first contact 21 is avoided.

The contacts 21, 22, 23, 24 are made of metallic material having good electrical conductive capability, such as copper, aluminum, and so on. In order to ensure good electrical contact and attain an aesthetically pleasing surface, an anticorrosion coating can be formed on an outer surface of each of the contacts 21, 22, 23, 24. The anticorrosion coating is preferably made of nickel. The insulators 25 are preferably made of polyamide resin.

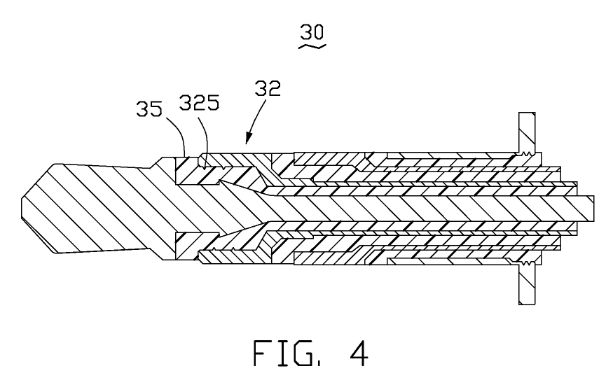

Referring to FIG. 4, a cable connector plug 30 in accordance with a second preferred embodiment of the present invention is shown. The cable connector plug 30 is similar in principle to the cable connector plug 20 of the first embodiment, except that the cable connector plug 30 includes a second contact 32 having one or more first anti-rotation members 325. The first anti-rotation member(s) 325 is/are configured to lockingly engage with a corresponding one of insulators 35. For example, the first anti-rotation member(s) 325 can include a plurality of protrusions or one or more beads. The protrusions can be contiguous elongated protrusions or discrete protrusions. In this embodiment, the first anti-rotation member 325 is a screw thread provided on an inner surface of a contact portion of the second contact 32. The insulator 35 is in immediate contact with the screw thread, so that a bonding strength between the insulator 35 and the second contact 32 is increased. Accordingly, when the cable connector plug 30 is inserted into a mating socket of a housing of a complementary connector and rotated relative to the housing, displacement as between the second contact 32 and a first contact (not labeled) is avoided.

In an alternative embodiment of the cable connector plug 20, the second anti-rotation member 245 can instead include a plurality of protrusions or one or more beads or a screw thread formed at the inner surface 243 of the extension portion 241 of the fourth contact 24. The protrusions can be contiguous elongated protrusions or discrete protrusions. The second anti-rotation member is configured to lockingly engage with the corresponding insulator 25.

In another alternative embodiment of the cable connector plug 20, the first anti-rotation member 225 can be omitted. That is, the cable connector plug 20 only has a single anti-rotation member, which is the anti-rotation member 245 at the inner surface 243 of the extension portion 241 of the fourth contact 24.

In a further alternative embodiment of the cable connector plug 20, the second anti-rotation member 245 can instead be provided at an inner surface of the cylindrical portion 240 of the fourth contact 24. This second anti-rotation member is configured to lockingly engage with the corresponding insulator 25.

It is should be noted that the above-described anti-rotation members of the cable connector plugs are not limited to the configurations provided. Each anti-rotation member can instead include any of various other suitable structures not described herein. For example, one or more non-planar structures can be formed on the inner surface of at least one of the second, the third, and the fourth contacts, whereby each of the anti-rotation members prevents or avoids the occurrence of displacement as between adjacent contacts of the cable connector plug. In other alternative embodiments, any two or all three of the insulators 25 of the cable connector plug 20 can be joined to each other at rear ends thereof, and any two or all three of the insulators 35 of the cable connector plug 30 can be joined to each other at rear ends thereof.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable connector plug, comprising:
a first contact, a second contact, and a first insulator portion, the first and second contacts being insulated from each other by the first insulator portion, wherein the second contact comprises an annular contact portion, the annular contact portion surrounds the first insulator portion, the annular contact portion comprises a first anti-rotation member at an inner side thereof, and the first insulator portion is fixedly engaged with the first anti-rotation member such that the annular contact portion cannot rotate relative to the first insulator portion.

2. The cable connector plug according to claim 1, wherein the first anti-rotation member is selected from the group consisting of at least one of a protrusion, a depression, and a groove.

3. The cable connector plug according to claim 2, wherein the first anti-rotation member is selected from the group consisting of at least one of a screw thread groove and a screw thread.

4. The cable connector plug according to claim 1, wherein the first contact comprises a contact portion, an extension portion extending rearwardly from the contact portion along an axis of the cable connector plug, and a rear portion extending rearwardly from the extension portion, the second contact further comprises a cylindrical extension portion extending rearwardly from the annular contact portion, and a rear portion extending rearwardly from the extension portion, the extension portions of the first and second contacts are coaxially arranged in that order from an inside of the cable connector plug, the contact portions of the first and second contacts are insulated from each other by a ring portion of the first insulator portion, and the extension portions of the first and second contacts are insulated from each other by a cylindrical portion of the first insulator portion.

5. The cable connector plug according to claim 4, further comprising a third contact and a second insulator portion, wherein the third contact comprises an annular contact portion, a cylindrical extension portion extending rearwardly from the contact portion, and a rear portion extending rearwardly from the extension portion, the extension portions of the first, second, and third contacts are coaxially arranged in that order from the inside of the cable connector plug, diameters of the extension portions of the first, second, and third contacts increase in that sequence, the contact portions of the second and third contacts are insulated from each other by a ring portion of the second insulator portion, and the extension portions of the second and third contacts are insulated from each other by a cylindrical portion of the second insulator portion.

6. The cable connector plug according to claim 5, further comprising a fourth contact and a third insulator portion, wherein the fourth contact comprises a cylindrical contact portion, an annular extension portion extending rearwardly from the contact portion, and a rear portion extending from the extension portion, the extension portions of the first, second, third, and fourth contacts are coaxially arranged in that order from the inside of the cable connector plug, diameters of the extension portions of the first, second, third, and fourth contacts increase in that sequence, the contact portions of the third and fourth contacts are insulated from each other by a ring portion of the third insulator portion, and the extension portions of the third and fourth contacts are insulated from each other by a cylindrical portion of the third insulator portion.

7. The cable connector plug according to claim 6, wherein the first, second, and third insulator portions are made of polyamide resin.

8. The cable connector plug according to claim 6, wherein the first, second, third, and fourth contacts are each made of metallic material.

9. The cable connector plug according to claim 6, further comprising an anticorrosion coating deposited on an outer surface of each of the first, second, third, and fourth contacts.

10. The cable connector plug according to claim 9, wherein the anticorrosion coating is made of nickel.

11. The cable connector plug according to claim 6, wherein the fourth contact defines a second anti-rotation member at an inner side of the extension portion thereof, and the third insulator portion is fixedly engaged with the fourth anti-rotation member such that the extension portion of the fourth contact cannot rotate relative to the third insulator portion.

12. The cable connector plug according to claim 11, wherein the second anti-rotation member is selected from the group consisting of at least one of a protrusion, a depression, and a groove.

13. The cable connector plug according to claim 12, wherein the second anti-rotation member is selected from the group consisting of at least one of a screw thread groove and a screw thread.

14. A cable connector plug, comprising:
a first contact, a second contact, a third contact, a fourth contact, and a plurality of insulator portions, the first, second, third and fourth contacts being insulated from each other by the insulator portions respectively, wherein the fourth contact comprises a cylindrical contact portion, the cylindrical contact portion surrounds one of the insulator portions that is between the third and fourth contacts, the cylindrical contact portion comprises an anti-rotation member at an inner side thereof, and said one of the insulator portions is fixedly engaged with the anti-rotation member such that the cylindrical contact portion cannot rotate relative to said one of the insulator portions.

15. The cable connector plug according to claim 14, wherein the first contact comprises a contact portion, an extension portion extending rearwardly from the contact portion along an axis of the cable connector plug, and a rear portion extending rearwardly from the extension portion, the second and third contacts each comprise an annular contact portion, a cylindrical extension portion extending rearwardly from the contact portion, and a rear portion extending rearwardly from the extension portion, the fourth contact further comprises an annular extension portion extending rearwardly from the contact portion, and the extension portions of the first, second, third, and fourth contacts are coaxially arranged in that order from an inside of the cable connector plug.

16. The cable connector plug according to claim 14, wherein the insulator portions are made of polyamide resin.

17. The cable connector plug according to claim 14, wherein the first, second, third, and fourth contacts are each made of metallic material.

18. The cable connector plug according to claim 14, further comprising an anticorrosion coating deposited on an outer surface of each of the first, second, third, and fourth contacts.

19. The cable connector plug according to claim 18, wherein the anticorrosion coating is made of nickel.

20. A cable connector plug, comprising:
a first contact, a second contact, and an insulator portion, the first and second contacts being insulated from each other by the insulator portion, wherein the second contact comprises a peripheral contact portion, the peripheral contact portion abuttingly surrounds the insulator portion, the peripheral contact portion comprises an anti-rotation structure at an inner side thereof, and the peripheral contact portion is non-rotatable relative to the insulator portion by reason of abutting interengagement between the anti-rotation structure and one or more complementary structures of the insulator portion.
